(19) United States
(12) Patent Application Publication
(10) Pub. No.: US 2013/0255977 A1
(43) Pub. Date: Oct. 3, 2013

(54) Control for Motor Grader Curb Operations

(71) Applicants: Michael Braunstein, Washington, IL (US); Yongliang Zhu, Dunlap, IL (US)

(72) Inventors: Michael Braunstein, Washington, IL (US); Yongliang Zhu, Dunlap, IL (US)

(73) Assignee: CATERPILLAR, INC., Peoria, IL (US)

(21) Appl. No.: 13/431,688

(22) Filed: Mar. 27, 2012

(51) Int. Cl. E02F 3/84; G06F 19/00

(52) U.S. Cl. 172/4.5; 701/50; 701/41

(57) ABSTRACT

A method is provided for controlling a motor grader having a blade, a blade shift actuator, a sensor to detect a distance to a curb, one or more steerable wheels, a steering actuator, an articulated frame, and an articulation actuator. In one aspect, an object sensor is located and configured to determine a gap between the blade and the curb, and to maintain the gap at a predetermined value in the absence of user intervention by automatically manipulating one or more of the blade shift actuator, steering actuator, and articulation actuator. The determination as to which one or more of the actuators to use in maintaining the blade gap may be made based on a mode selection by an operator of the motor grader.

### TECHNICAL FIELD OF THE DISCLOSURE

The present disclosure relates to motor grader operation and, more particularly, relates to motor grader blade and steering control for operations near roadway markers such as curbs.

### BACKGROUND OF THE DISCLOSURE

Motor graders are earth-moving machines that are employed in a variety of tasks, including as shaping tools to create banks, ditches, and berms, as surface preparation tools for scarification and other surface treatments, and as finishing tools to refine construction site and roadway surfaces to final shape and contour. Although not universally applicable, motor graders typically include a front frame and a rear frame that are joined at an articulation joint. The rear frame includes compartments for housing the power source and cooling components, the power source being operatively coupled to the rear wheels for primary propulsion of the machine. The rear wheels are typically arranged in tandem sets on opposing sides of the rear frame. The front frame typically includes a pair of front wheels, and supports an operator station and a blade assembly.

In order to create a desired shape, contour, and/or finish, the motor grader blade can generally be rotated, tilted, raised, lowered, and/or shifted side to side to any of a large number of positions with fine resolution of motion. Thus, although the blade is affixed to the motor grader, the relative blade position is highly variable.

Overall steering of the machine is generally a function of both front wheel steering (typically referred to as “steering”) and articulation of the front frame relative to the rear frame (typically referred to as “articulation”). This allows the machine to navigate relatively tight arcs and circles such as may occur at curves or turns in a roadway. Given the ability to control the blade position, frame articulation, and wheel steering, the operation of a motor grader presents users with a complex task. The operator interface to control the machine generally includes various hand-operated controls to steer the front wheels, position the blade, control frame articulation, and control auxiliary devices such as rippers and plows, while also including various displays for monitoring machine conditions and/or functions.

During tasks that require fine blade and machine positioning, even experienced operators will often need to slow down the pace of operation to avoid damaging the roadway or impacting nearby markers, while ensuring that the blade reaches the limits of the area to be treated. As used herein, the term “marker” refers to a structure to be followed such as a curb. While a marker need not be specifically marked with a visible paint or other marking substance, the term “marker” does not exclude such visually marked structures.

In cul-de-sac grading, the operator is required to maneuver the motor grader around a tightly curved path while maintaining the blade at a desired distance from curbs and other obstacles. This requires that the operator simultaneously control the blade, front wheel steering and frame articulation angle. Failure to properly control any one of these variables in such circumstances can result in blade-obstacle collisions or incomplete grading.

Certain systems seek to address portions of this problem. For example, U.S. Appl. No. 2010/0010703 to Coats et al. discloses a method for machine guidance that is directed to maintaining a machine position relative to a marker. While the system of Coats et al. does assist operators by automating certain machine positioning tasks, it does not address blade positioning for sensitive operations such as cul-de-sac grading and contouring.

The present disclosure is directed to a machine control system and method to improve motor grader operations in order to address one or more of the problems or shortcomings set forth above. However, it should be appreciated that the solution of any particular problem is not a limitation on the scope of this disclosure and the attached claims except to the extent expressly noted. Additionally, this background section discusses problems and solutions noted by the inventors; the inclusion of any problem or solution in this section is not an indication that the problem or solution represents known prior art except as otherwise expressly noted. With respect to prior art that is expressly noted as such, the summary thereof is not intended to alter or supplement the prior art document itself; any discrepancy or difference should be resolved by reference to the prior art.

### SUMMARY OF THE DISCLOSURE

In accordance with one aspect of the present disclosure, a method of controlling a motor grader is provided. The method includes receiving an operator selection from an operator of the motor grader indicating that the operator desires automatic blade control. A distance between a feature of a roadway marker and an edge of the motor grader blade closest to the roadway marker is automatically determined via an object sensor and the blade is automatically moved relative to the roadway marker such that the distance between the feature of the roadway marker and the edge of the blade closest to the roadway marker substantially conforms to a target distance.

In accordance with another aspect of the present disclosure, a motor grader is provided comprising an articulated frame having one or more steerable traction devices at one end of the articulated frame and one or more propulsive traction devices at an opposite end of the articulated frame. A blade is positioned beneath the articulated frame to grade a ground surface beneath the motor grader, and an articulation actuator is located and configured to establish an articulation angle of the articulated frame. A steering actuator is located and configured to establish a steering angle of the one or more steerable traction devices, and a shift actuator is located and configured to shift the blade relative to the articulated frame. At least one object sensor detects a roadway marker adjacent the motor grader and provides information indicative of a distance between the blade and the roadway marker. A controller is included to receive a mode selection signal from a mode selector switch identifying a desired mode of operation from among a plurality of available modes including a manual mode, an automatic blade control mode wherein the controller controls the blade shift actuator to maintain a target distance between the blade and the roadway marker, an automatic blade and articulation control mode wherein the controller controls the blade shift actuator and the articulation actuator to maintain the target distance between the blade and the roadway marker as the machine is steered by the operator, and a fully automatic control mode wherein the controller controls the blade shift actuator, articulation actuator, and steering actuator to direct the motor grader while maintaining the target distance between the blade and the roadway marker.

In accordance with yet another aspect of the disclosure, a method is provided for controlling a motor grader having a blade, a blade shift actuator, an object sensor to detect a distance to a curb, one or more steerable wheels, a steering actuator, an articulated frame, and an articulation actuator. The method includes periodically determining via the object sensor a gap between the blade and a feature of the curb and maintaining the gap at a target distance in the absence of user intervention by automatically manipulating one or more of the blade shift actuator, steering actuator, and articulation actuator.

Additional and alternative feature and aspects of the disclosed methods and systems will become apparent from reading the detailed specification in conjunction with the included drawing figures.

### BRIEF DESCRIPTION OF THE DRAWINGS

FIG. 1 is a pictorial representation of a side view of an exemplary motor grader;

FIG. 2 is a pictorial representation of a top view of an exemplary motor grader;

FIG. 3 is a diagrammatic illustration of a top view of an exemplary motor grader illustrating steering and articulation angles;

FIG. 4 is a control schematic showing controller inputs and outputs used in implementing various embodiments of the disclosed systems and methods;

FIG. 5 is a flow chart illustrating an overview process for operation of certain aspects of a motor grader machine based on a mode selection by the operator;

FIG. 6 is a flow chart illustrating an automatic blade control process in accordance with one implementation of the disclosure;

FIG. 7 is a flow chart illustrating an automatic blade and articulation control process in accordance with one implementation of the disclosure;

FIG. 8 is a flow chart illustrating an automatic blade, steering, and articulation control process in accordance with one implementation of the disclosure; and

FIG. 9 is a schematic example of a display for allowing user selection of certain parameters.

### DETAILED DESCRIPTION OF THE DISCLOSURE

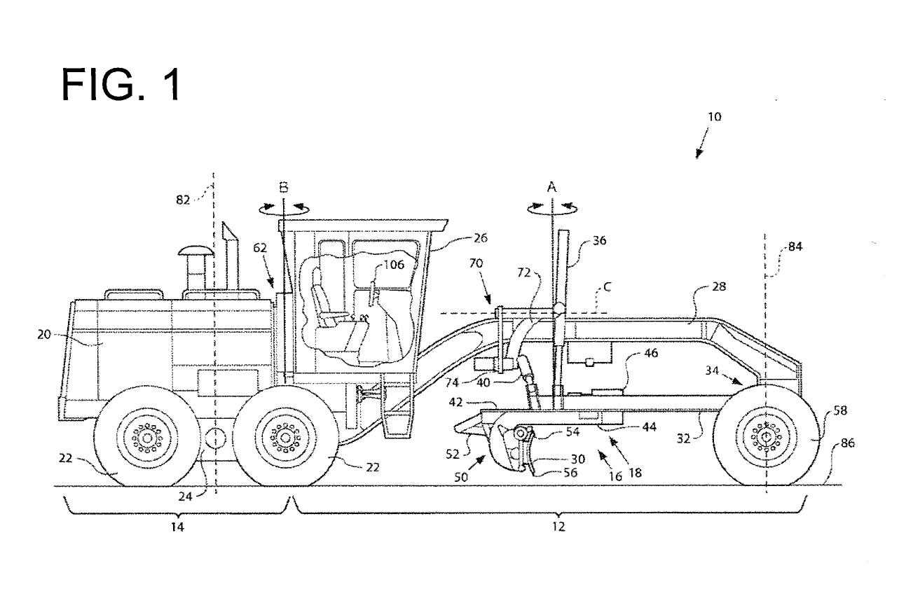

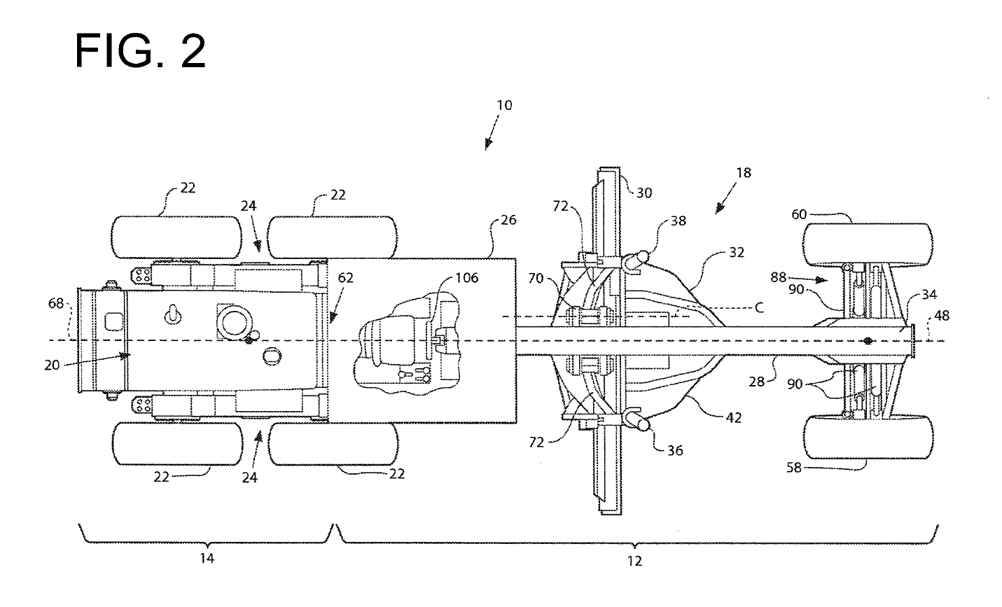

The present disclosure provides a system and method for motor grader steering and blade control for operations relative to roadway markers such as, but not limited to, curbs and the like. Referring now to FIG. 1 and FIG. 2, there is shown an exemplary motor grader in accordance with one embodiment of the present disclosure. The illustrated motor grader 10 includes a front frame 12, rear frame 14, and a work implement 16. In the context of a motor grader, the work implement 16 is typically a blade assembly 18, also sometimes referred to as a drawbar-circle-moldboard assembly (DCM). The blade assembly 18 may include a separate blade portion and a moldboard portion, and such arrangements will be referred to herein collectively as the blade, moldboard, or DCM.

The rear frame 14 includes a power source, not shown, contained within a rear compartment 20. The power source is typically operatively coupled through a transmission, not shown, to rear traction devices or wheels 22 for primary machine propulsion. As shown, the rear wheels 22 are operatively supported on tandems 24 which are pivotally connected to the machine between the rear wheels 22 on each side of the motor grader 10. The power source may be, for example, a diesel engine, a gasoline engine, a natural gas engine, or any other engine known in the art. The power source may additionally or alternatively comprise a battery, fuel cell or other electrical power storage device known in the art. The transmission may be a mechanical transmission, hydraulic transmission, or any other transmission type known in the art and may be operable to produce multiple output speed ratios (or a continuously variable speed ratio) between the power source and driven traction devices.

The front frame 12 supports an operator station 26 containing various operator controls, along with a variety of displays or indicators used to convey information to the operator, used for primary operation of the motor grader 10. The front frame 12 also includes a beam 28 that supports the blade assembly 18. The blade assembly 18 includes a drawbar 32 pivotally mounted to a first end 34 of the beam 28 via a ball joint (not shown). The position of the drawbar 32 is controlled by three hydraulic cylinders: a right lift cylinder 36 and left lift cylinder 38 that control vertical movement, and a center shift cylinder 40 that controls horizontal movement. As used herein, the term “blade shift” refers to a sideways shifting of the blade via the center shift cylinder 40.

The right and left lift cylinders 36, 38 are connected to a coupling 70 that includes lift arms 72 pivotally connected to the beam 28 for rotation about axis C. A bottom portion of the coupling 70 has an adjustable length horizontal member 74 that is connected to the center shift cylinder 40.

The drawbar 32 includes a large, flat plate, commonly referred to as a yoke plate 42. Beneath the yoke plate 42 is a circular gear arrangement and mount, commonly referred to as the circle 44. The circle 44 is rotated by, for example, a hydraulic motor referred to as the circle drive 46. In other embodiments, an electric motor is used to facilitate rotation of the circle 44.

Whatever the technology used to drive the circle drive 46, rotation of the circle 44 by the circle drive 46 rotates the attached blade 30 about an axis A perpendicular to a plane of the drawbar yoke plate 42. As used herein, the blade cutting angle refers to the angle of the blade 16 relative to a longitudinal axis 48 of the front frame 12. For example, at a zero degree blade cutting angle, the blade 30 is aligned across the machine 10 at a right angle to the longitudinal axis 48 of the front frame 12 and beam 28, as shown in FIG. 2.

A pivot assembly 50 between the blade 30 and the circle 44 allows for tilting of the blade 30 relative to the circle 44. To this end, a blade tip cylinder 52 is used to tilt the blade 30 forward or rearward. In other words, the blade tip cylinder 52 is used to tip or tilt a top edge 54 relative to the bottom cutting edge 56 of the blade 30, and the occurrence or extent of this tilting is commonly referred to as blade “tip.”

As noted above, steering of the motor grader 10 is accomplished through a combination of front wheel steering and machine articulation. As shown in FIG. 2, steerable traction devices (right wheel 58 and left wheel 60 in the illustrated example) are associated with the first end 34 of the beam 28. The right wheel 58 and left wheel 60 may be rotatable and tiltable for use during steering and leveling of a work surface 86. The right wheel 58 and left wheel 60 are connected via a steering apparatus 88 that may include a tie rod 90 for pivoting the wheels in unison about pivot points 80 as well as one or more wheel tilt actuators 91 to provide front wheel tilt.

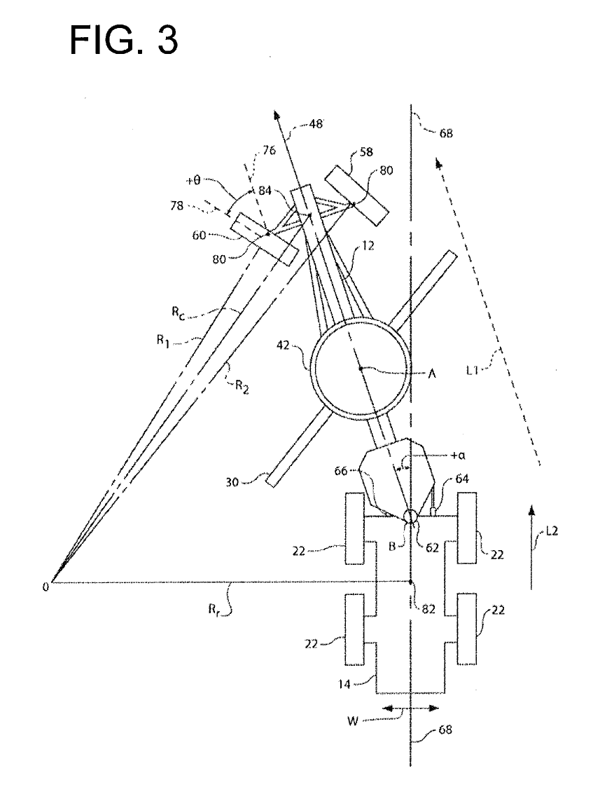

Referring to FIGS. 1 and 3, the motor grader 10 includes an articulation joint 62 that pivotally connects front frame 12 and rear frame 14 at an articulation axis B. Both a right articulation cylinder 64 and a left articulation cylinder 66 are connected between the front frame 12 and the rear frame 14 on opposing sides of the machine 10. The right and left articulation cylinders 64, 66 are used to pivot the front frame 12 relative to the rear frame 14, separated at articulation axis B. In the illustrative example of FIG. 2, the motor grader 10 is positioned in the neutral or zero articulation angle position wherein the longitudinal axis 48 of the front frame 12 is aligned with a longitudinal axis 68 of the rear frame 14.

FIG. 3 provides a top view of the motor grader 10 with the front frame 12 rotated at an articulation angle α defined by the intersection of longitudinal axis 48 of front frame 12 and longitudinal axis 68 of the rear frame 14, the intersection corresponding with the position of articulation joint 62. This illustration follows the convention that a positive α value is indicative of a left articulation from the perspective of an operator facing forward, while a negative α value would be indicative of a right articulation. A front wheel steering angle θ is defined between a longitudinal axis 76 parallel to the longitudinal axis 48 of front frame 12, and a longitudinal axis 78 of the front wheels 58, 60, the angle θ having an origin at the pivot point 80 of the front wheels 58, 60. This is demonstrated in connection with left front wheel 60, but also applies to the right front wheel 58. It will be appreciated that in order for the turn centers of the front wheels 58, 60 to coincide as shown, one may have a slightly different steering angle from the other, with the outside wheel generally having a longer radius.

As can be seen, the motor grader 10 has many degrees of freedom, both in steering and in blade position, that provide the ability to perform precise work; however, these various degrees of freedom must be carefully controlled to provide the best work product and operator experience. As noted above, cul-de-sac operations can be especially challenging, given the need to precisely steer the motor grader 10 while simultaneously positioning the blade assembly 18 with sufficient accuracy, particularly in the shift dimension, to avoid curb damage or incomplete grading.

In an embodiment of the disclosure, a number of special machine modes are provided including an automatic blade mode wherein the blade assembly 18 is automatically positioned relative to a road marker such as a curb or roadway edge while the operator controls the positioning of the machine 10 via steering and articulation. In a further embodiment, machine articulation is automated as well, such that the articulation and blade shift are controlled cooperatively to maintain a desired spacing between the edge of the blade assembly 18 and the marker. In yet another embodiment, a fully automated mode provides automatic control of blade side shift, frame articulation, and wheel steering. As an optional aspect of one or modes, machine speed may be controlled or limited. These various modes ease the chore of cul-de-sac grading near curbs and enhance work product uniformity during long stretches of straight-line grading near a road edge or curb.

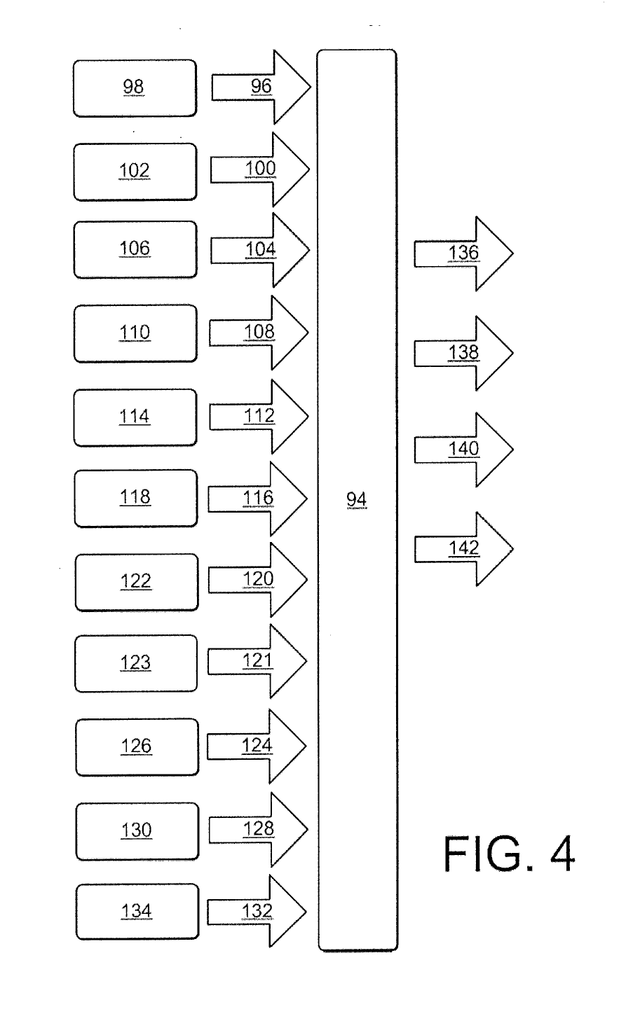

Referring to FIG. 4, although other physical implementations are possible, an embodiment of the disclosure employs a controller 94 for receiving and evaluating machine commands such as mode selections. The controller 94 is also configured to receive and evaluate machine data, such as steering angle, blade angle, blade shift, blade tilt, machine speed, etc. In addition, the controller 94 may receive and evaluate sensor data, such as the location of the roadway marker adjacent the machine, the curvature of, or downrange points on, the marker, and so on. The controller 94 also provides data and control outputs as needed to execute the methodology described herein depending upon the mode selected, e.g., setting the shift of the blade assembly 18, setting the steering and tilt angle of one or more machine wheels, setting the angle of articulation, etc.

The controller 94 is implemented, in an embodiment, as a computing device incorporating one or more microcontrollers and/or microprocessors (collectively referred to herein as a “processor” or “digital processor”). The controller 94 operates by reading or loading computer-executable instructions, or code, from a nontransitory computer-readable medium such as a nonvolatile memory, a magnetic or optical disc memory, a flash drive, and so on. The controller 94 may execute the instructions in a time-shared manner, a multi-thread manner, or any other suitable execution technique. It will be appreciated that data used by the controller 94 in the execution of the computer-executable instructions may be stored and read out as well, or may be created in real time. The controller 94 has one or more interfaces to receive data and/or commands, and one or more outputs to output data and/or commands such as those discussed above. The controller 94 may be an isolated controller or is alternatively implemented within another controller that also serves other machine functions.

In the illustrative embodiment shown in FIG. 4, the controller 94 receives a steering angle sensor input signal 96 from one or more steering angle sensors 98. This steering angle sensor input signal 96 provides a signal indicative of the steering angle. As used herein, a signal is indicative of a specified quantity or value when it directly or indirectly conveys or can be used to calculate, directly or indirectly, that quantity or value. With respect to all inputs, it will be appreciated that each signal may be communicated over a dedicated physical line or channel, or may be multiplexed over a multi-signal channel, as may be the case in the event that the machine 10 utilized a managed machine area network. In either case, one or more input signals may be communicated at least partially by wireless transmission.

The controller 94 further receives a steering input signal 100 from one or more operator steering controls 102 indicative of an operator steering command. The operator steering controls 102 may include a joy stick as shown in FIGS. 1-2, or any other type of operator input device, such as a dial, keyboard, pedal or other devices known in the art. In one embodiment a steering angle sensor is configured to sense the rotation or position of the operator steering controls 102 and to provide a steering input signal 100 indicative of a steering angle θ.

In an embodiment, the controller 94 further receives an articulation input signal 104 from one or more articulation sensors 106, with the articulation input signal 104 being indicative of the articulation angle α at the axis B between the rear frame 14 and front frame 12. In a further embodiment, the one or more articulation sensors 106 include a pivot sensor disposed at articulation joint 62 to sense rotation about articulation axis B. Additionally or alternatively, the one or more articulation sensors 106 may include one or more sensors configured to monitor the extension of right and/or left articulation cylinders 64, 66. It will appreciated that the steering angle sensors 98, steering wheel sensor (at operator steering controls 102), articulation sensors 106, as well as other sensors for rotational movement may be, for example, potentiometers, extension sensors, proximity sensors, angle sensors, rotary encoders, and the like.

In an embodiment, one or more blade position sensors 110 provide a blade position input signal 108 to the controller 94, the blade position input signal 108 being indicative of the actual position of the blade 30. Such sensors may be configured to sense blade position directly or may be configured to sense blade position indirectly (for example from pin angle sensors, etc.) based on the positions of the related hydraulic actuators. In an embodiment, the blade position in at least the shift direction is sensed via a non-contact sensor (“object sensor”), e.g., digital camera, LADAR, LIDAR, etc. The blade position input signal 108 may also indicate a position of the blade 30 in other dimensions as well, such as tilt, tip, and rotation.

Similarly, a blade position command input signal 124 originating from an operator blade positioning input device 126 provides the controller 94 with information regarding an operator's inputs to position the blade 30. The operator blade positioning input device 126 may be any suitable operator control for setting blade position, including but not limited to one or more joysticks, levers, and the like.

One or more transmission sensors 114 may be used, associated with the transmission, to provide a gear input signal 112 indicative of a current gear or output ratio associated with the machine transmission. Alternatively, the gear input signal 112 may be provided by signals associated with operator controls for the transmission (not shown).

Although the machine configuration can be known from the above referenced data inputs to the controller 94, the position of the machine and blade relative to a roadway marker such as a curb cannot be discerned from these inputs other than perhaps by extrapolation from a past known relationship. To this end, in order to provide real time information regarding the location of a marker adjacent the machine 10 and/or ahead of the machine 10, one or more marker sensors 118 (“object sensors”) provide a marker position input signal 116 to the controller 94. In an embodiment, the one or more marker sensors 118 include only a single sensor, which is selectively directed to one side of the machine 10 or the other depending upon which side of the machine 10 the roadway marker is known or detected to be located.

Additionally or alternatively, the one or more marker sensors 118 may include multiple stationary sensors or a more limited number of scanning sensors, or a combination of stationary and scanning sensors. A scanning sensor in this context is one that can be dynamically directed to a different field of view, e.g., it may be selectively directed forward or sideways, downward or sideways, left side or right side, etc. In addition, virtual sensor arrays may be implemented from a single sensor via synthetic array heterodyne detection schemes and the like to enhance the capabilities of individual sensors.

The one or more marker sensors 118 may include one or more LIDAR (light detection and ranging) sensors, one or more LADAR (laser detection and ranging) sensors, one or more digital cameras, and/or other types of sensors. It will be appreciated that LIDAR sensing involves the emission and detection of UV, visible or near infrared radiation to determine a distance between the sensor and a target object, e.g., the roadway marker. Similarly, LADAR involves the use of laser radiation to detect the distance to the target object. In addition to employing coherent radiation instead of the non-coherent radiation used in LIDAR, LADAR may also operate in areas of the electromagnetic spectrum not used by LIDAR.

While LADAR can generally provide better long range accuracy than LIDAR, the systems and processes of this disclosure entail short range detection. Similarly, cameras typically provide accurate ranging information only at short ranges relative to both LADAR and LIDAR, but cameras do provide suitable ranging capabilities within the close ranges contemplated herein. As such, the selection of sensor type, number, and position may be resolved by issues of cost and availability as well as any considerations of multi-purposing of sensors rather than questions of efficacy. For example, a single sensor may be used for both object detection and personnel detection, or for other additional purposes.

In an embodiment, all or a subset of the one or more marker sensors 118 in conjunction with the processor may be configured to preferentially detect a specific marking, material, or quality associated with the roadway marker. For example, a curb can be characterized by a longitudinal block of a certain color or color range bounded by linear boundaries to other colors such as the color of soil, grass, etc.

In environments where the linear character of the curb is not discernable or the color of the curb is too close to the colors of other surfaces bounding the curb, a non-naturally occurring color may be applied to the curb to provide a signal for the one or more marker sensors 118 to preferentially detect. For example, a continuous stripe of bright white or neon orange paint may be applied to the curb to aid in detection and/or ranging. In this embodiment, the detected non-naturally occurring color would identify a target, e.g., the curb, upon which ranging occurs.

In an embodiment, a propulsion input signal 120 is provided to the controller 94 from one or more operator-controlled propulsion interface devices 122, e.g., acceleration pedals or levers, transmission mode selectors, etc. Such interface devices 122 may be located in the operator station 26. An engine speed input signal 121 is also provided to the controller 94 in an embodiment, with the associated engine speed data originating from an RPM sensor 123 or the like.

A machine position sensor cluster 130 is configured to provide the controller 94 with a machine position input signal 128. The machine position sensor cluster 130 may include without limitation one or more accelerometers, inclinometers, inertial measurement units, and other orientation sensors, as well as a GPS or other positioning system. As such, the machine position input signal 128 provides the controller 94 with information regarding both the position and orientation of the machine 10.

As noted above, a mode selection option for the operator is enabled in an embodiment of the disclosure. The mode selection option may be presented via a mode selector switch 134 which provides a mode selection signal 132 to the controller 94. As will be discussed in greater detail below, the mode selector switch 134 may be employed to select amongst various modes of operation including, for example, a blade automation mode, a blade and articulation automation mode, a full auto mode and a normal or manual mode.

Before discussing these modes and the operation and configuration of the controller 94 to implement operations in the various modes, exemplary outputs of the controller 94 will be briefly identified and discussed. It will be appreciated that each output signal may be provided over a dedicated physical line or channel, or all outputs may be multiplexed over a lesser number of non-dedicated lines or channels. Moreover, one or more outputs may be communicated at least partially by wireless transmission.

In order to maintain machine position for modes requiring such, the controller 94 provides a steering output 136 to set the steering angle of the front wheels of the machine 10. The steering output 136 may be provided to a system controller that implements the steering command. By way of example, the steering output 136 may be provided to and processed by the same logic and hardware that process the steering commands from the operator steering controls, which further actuates hydraulic cylinders (not shown) of the steering apparatus 88 so as to implement the steering command. As will be discussed later, the steering output 136 may be overridden by the operator in an embodiment.

For controlling the articulation of the machine 10 when in a mode requiring such control, the controller 94 provides an articulation output 138. As with other outputs, the articulation output 138 may be provided to another controller or subsystem responsible for implementing articulation commands. Alternatively, the articulation output 138 may be implemented via independent hardware and processing. In either case, the indicated articulation command is used to control machine frame articulation, e.g., via the articulation actuators 64, 66.

In order to control the position of the blade 30 to maintain distance between the blade and the roadway marker during operations (“target distance”), the controller 94 provides a blade shift output 140. The blade shift output 140 may be provided to a control solenoid associated with a hydraulic control valve for the center shift cylinder 40 via the same hardware as the operator-input shift commands or via an independent channel or circuitry.

Finally, in some modes it may be desirable to control machine speed. To this end, the controller 94 provides a machine speed output 142. The machine speed output 142 may contain, or may be used to generate, commands for controlling machine engine speed, drive speed, and/or transmission mode or range. For example, for rough ground conditions, it may desirable to maintain a constant torque at the traction elements, whereas in an environment having significant gradient variation, it may be desired to maintain a constant machine speed.

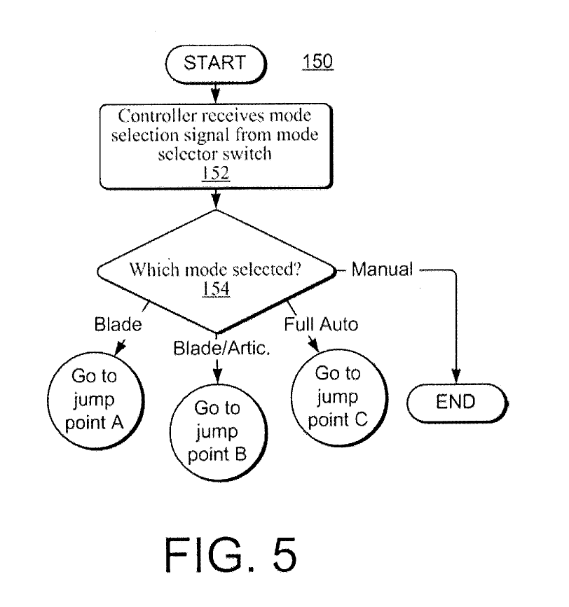

Exemplary processes utilized by the controller 94 in an embodiment to control blade distance to the roadway marker in various modes are shown in FIGS. 5-8. While the disclosure will exemplify these processes as being executed by the controller 94, it will be appreciated that the processes may be distributed as needed or desired in a given implementation. Moreover, it will be appreciated that the order of steps within each process is illustrative, and the steps need not occur in the given order unless otherwise apparent from the disclosure. Moreover, while the disclosure explains operations in various selectable modes, it is also contemplated, without departing from the scope of these teachings, for a machine in a particular implementation to support only a subset of the described modes, or indeed, to support only a single mode.

Referring now to FIG. 5, an overview process 150 is shown for operation of certain aspects of the machine based on a mode selection by the operator, e.g., by way of the mode selector switch 134. The process 150 is used in order to identify further processes for execution based on mode selection. At stage 152 of the process 150, the controller 94 receives a mode selection signal from the mode selector switch 134. The mode selection signal identifies a desired mode of operation, selected from among available modes, e.g., manual, automatic blade control, automatic blade and articulation control, and fully automatic control.

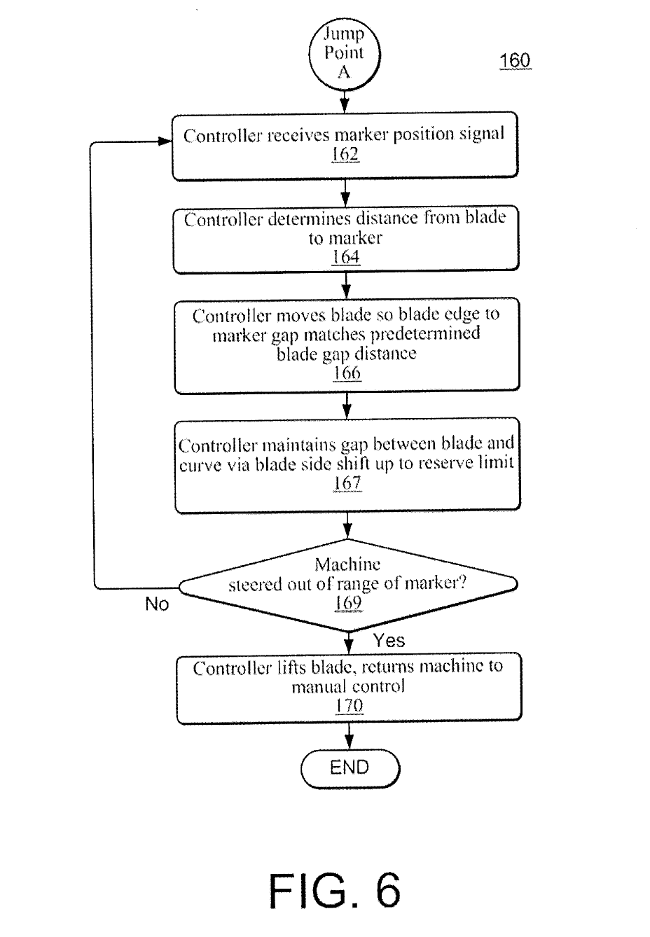

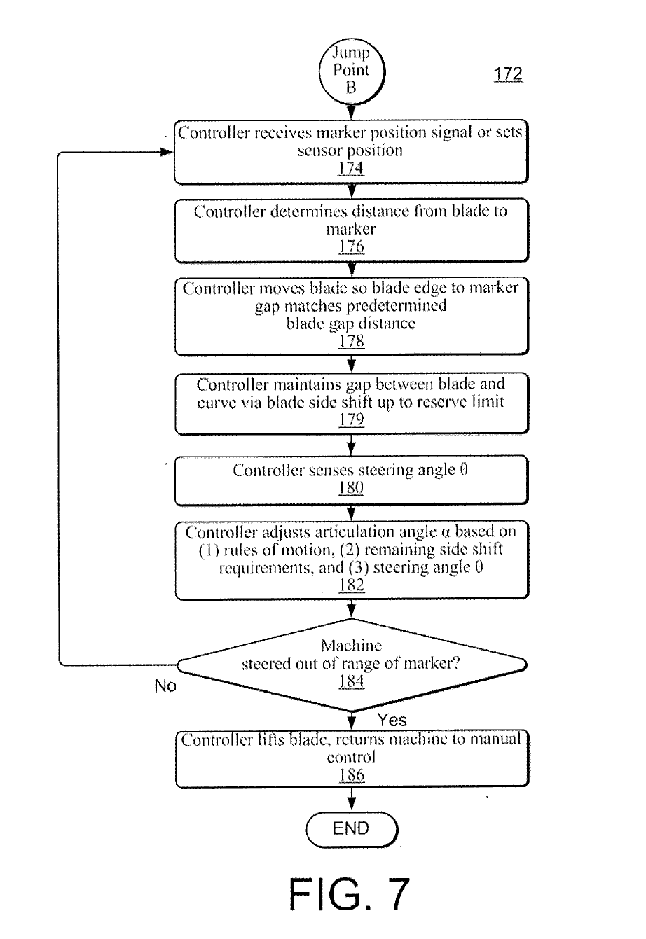

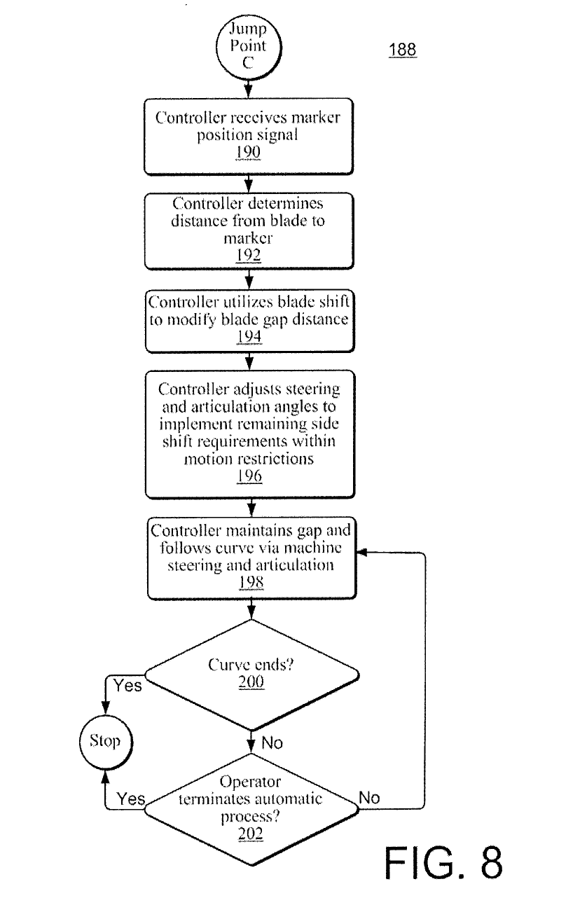

In the illustrated embodiment, the process 150 determines subsequently at stage 154 which of the available modes has been selected, and terminates if manual operation has been selected, continues to jump point A (see FIG. 6) if automatic blade control has been selected, continues to jump point B (see FIG. 7) if automatic blade and articulation control has been selected, and continues to jump point C (see FIG. 8) if fully automatic control has been selected. In an optional embodiment, the modes other than the manual mode may be locked out, i.e., not selectable, if the machine speed is higher than a predetermined acceptable speed.

Turning to FIG. 6, an automatic blade control process 160 is shown. The automatic blade control process 160 is entered at jump point A, and begins with optional stage 162, wherein the controller 94 receives a marker sensor position signal, e.g., an indication of whether a marker sensor such as a camera, LIDAR sensor, or other marker sensor is facing to the left of the machine 10 or to the right. Alternatively, the controller 94 may determine an appropriate direction for the marker sensor and position the marker sensor automatically.

For example, when an automatic mode is selected, in an embodiment having a single sensor, the controller 94 can scan the sensor on a first side of the machine 10, e.g., the right side, for a curb or other marker, and if one is found, maintain the sensor in that orientation. If a curb or other marker is not found in a scan of the right side, the controller 94 may then scan the sensor on the opposite side of the machine 10. In an embodiment wherein separate left and right facing sensors are used, the marker sensor position signal may indicate which marker sensor is to be active, e.g., on which side of the machine 10 the marker has been detected.

Prior to proceeding in the process 160, the controller 94 may prompt the operator via a visual display to set certain aspects of the blade positioning to the desired setting, e.g., to set a desired blade tip, tilt, and circle shift. Having determined the marker sensor position, the process 160 flows to stage 164, wherein the controller 94 determines the distance from the blade 30 to the detected marker, e.g., the curb or other marker. While a given sensor such as a camera, LIDAR sensor, LADAR sensor, etc. will typically only determine the distance between the sensor itself and the marker, the controller 94 may then process that distance information given the known sensor position relative to the machine and the known blade position relative to the machine to determine the distance from the blade edge to the marker.

In an embodiment, the detected marker structure may be displayed to the user, who then selects which feature to follow. For example, a square curb may have four or more linear features including those in the base, and the user can select a feature of the displayed structure against which distance is to be measured. In an alternative embodiment, the operator is also prompted to set an acceptable blade gap. For example, the operator may be shown a camera view of the blade and marker on a display and may set a gap on the screen visually or numerically, or may manually shift the blade while watching the display until the desired gap is achieved.

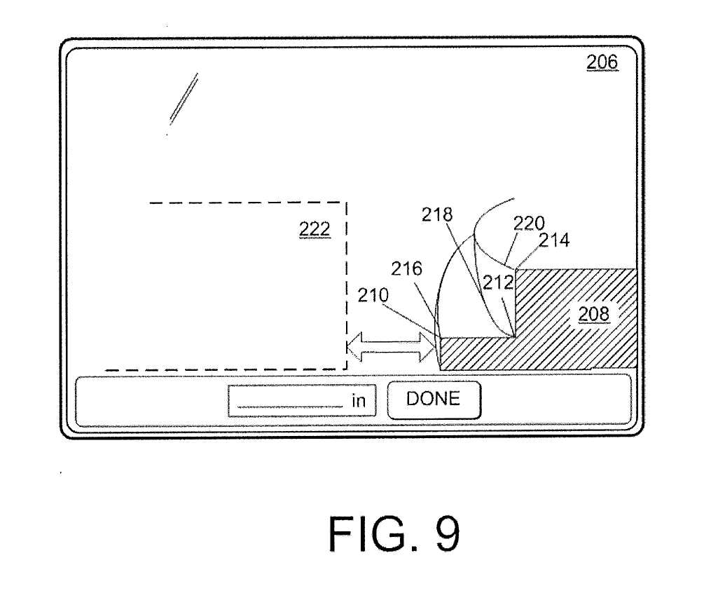

A schematic example of a display for allowing user selection of parameters is shown in FIG. 9. The illustrated selection display 206 shows the detected linear features of a curb 208 in cross-section as curb point A (210), curb point B (212) and curb point C (214). In an embodiment, a marking such as a bright paint may be applied to the curb, either along the entire length to be tracked or periodically, to enhance the ability of the sensor to detect and distinguish the curb or certain features of the curb.

Each curb point 210, 212, 214 is associated with a tracking curve, i.e., tracking curve A (216), tracking curve B (218), and tracking curve C (220). The blade 30 is represented in the display 206 by blade outline 222. In an embodiment, the display 206 includes one or more parameter fields allowing the operator to enter desired parameters. In the illustrated embodiment, the display 206 includes a blade gap field 224 in which the operator may enter a numerical blade gap, as well as a finish selection field 226 for selection when finished setting the gap. As noted above, the user may also set the blade gap manually while watching the display 206 or, in a further embodiment, may set the gap by manipulating the display itself via a cursor selection or touch screen operation.

In selecting a curb point to measure against, the operator also selects the corresponding tracking curve in an embodiment. Because the mechanisms associated with the blade 30 cannot react instantaneously, the curve allows the controller 94 to predict and accommodate upcoming curves and discontinuities. In this connection, note that the tracking curves 216, 218, 220 need not precisely track the selected curb point. Rather, a tracking curve may be interpolated across minor gaps or discontinuities of a particular curb point, such as a gap for a gutter grate, manhole cover opening, etc.

In an embodiment, the interpolated tracking curve during a discontinuity is comprised of a curve segment that connects the last non-interpolated point before the gap and the first non-interpolated point after the gap. The curve segment has a curvature in this embodiment that is substantially the average of the curve values immediately before and immediately after the gap. Local curvatures may be identified by a radius, a polynomial expression, or otherwise.

In some cases, the tracking curve may exhibit a termination, i.e., where there is no far side point on the curve visible, instead of a gap where a far side point can be detected. In such cases, when the blade 30 reaches a termination point, the tracking process may fix the blade position at its current position until the curve is again detected, terminate automatic blade control, or shift the blade 30 sideways away from the curb side. Other responses may be appropriate depending upon the implementation environment. For example, if the tracked curb or other marker is known to be circular or to follow some other predefined path, the tracking process may continue to track the virtual known curve even in the absence of a detectable actual curb or other marker.

Continuing with the process 160, if the user has not manually set the gap, the controller 94 moves the blade 30 at stage 166 to the extent needed so that the distance from the blade edge to the marker matches a target blade gap distance, which may be as little as about 30 mm or less, depending upon machine resolution of motion, up to much larger gap distances, as may be required when working near curbs having extended base portions. In an embodiment, the target blade gap distance is a preset value, and in an alternative embodiment the operator may select a target distance to be maintained as noted above.

At stage 167, as the machine 10 moves forward, the controller 94 maintains the gap between the blade 30 and the selected curve by adjusting blade side shift via the center shift cylinder 40. In an embodiment, the blade shift executed in stage 167 is limited to a predetermined percentage of the range of blade shift available to allow some reserve capacity to shift further if need be. For example, the shift may be limited at stage 167 to 75% of the total available range. A warning indicator is provided, in an embodiment, when the side shift reaches the preset limit value.

As the machine 10 proceeds along the marker, the controller determines at stage 169 whether the operator has steered the machine 10 out of range of the marker. If the operator has steered the machine 10 out of range of the marker, then the process 160 lifts the blade at stage 170 and reverts the machine to manual control. If instead it is determined at stage 169 that the operator has not steered the machine 10 out of range of the marker, the process 160 loops back to stage 162 to reevaluate and further refine blade position as the machine 10 moves forward. In an embodiment, a warning may be given before reverting to manual control. For example, a visual or audible warning may indicate that the blade gap distance is in danger of going out of range, that the machine is travelling too fast, etc.

In addition to the termination conditions noted above, one or more other conditions may also cause the machine 10 to revert to manual control. For example, in an embodiment, the process 160 is terminated and the machine 10 reverted to manual operation whenever the operator manipulates the blade side shift manually, e.g., via operator controls in the operator station 26.

If the automatic blade and articulation control mode was selected at stage 154 of process 150, then the controller 94 operates according to the automatic blade and articulation control process 172 shown in FIG. 7, which is initially similar to the automatic blade control process 160. The process 172 is entered at jump point B, and begins with optional stage 174, wherein the controller 94 receives a marker sensor position signal or determines an appropriate direction for the marker sensor and positions the marker sensor automatically as discussed above. Prior to continuing, the controller 94 may prompt the operator via a visual display to set certain aspects of the blade positioning to the desired setting, e.g., to set a desired blade tip, tilt, and circle shift, as discussed with respect to process 160.

The controller 94 then determines the distance from the blade 30 to the detected marker at stage 176 and moves the blade 30 at stage 178 to the extent needed so that the distance from the blade edge to the marker matches the preset blade gap distance if the user has not manually set the gap. As noted above with reference to FIG. 9, in an alternative embodiment, the detected marker structure may be displayed to the user, who then selects which feature to follow and sets an appropriate gap.

Subsequently as the machine 10 moves forward, the controller 94 maintains the gap initially set between the blade 30 and the selected curve by adjusting blade side shift via the center shift cylinder 40 at stage 179. In an embodiment, the blade shift is limited to less than the actual available range of blade side shift, e.g., 75% of the total available range. Again, a warning indicator may be provided when the side shift reaches the preset limit value.

In addition to checking and setting blade position, the controller 94 also controls the machine articulation in the instant embodiment. The control of articulation serves three purposes, namely ensuring compliance with certain rules of motion, providing additional side shift capability, and allowing the rear wheels to track the front wheels to the extent such is compatible with the other goals of articulation. Thus, the controller senses the steering angle θ, e.g., via steering input signal 100 at stage 180. At stage 182, the controller 94 adjusts the frame articulation angle α (as sensed via the articulation input signal 104 and controlled via the articulation output 138 to right and left articulation cylinders 64, 66) based on (1) certain rules of travel, e.g., disallowing impact of rear wheels on curb, (2) the amount of remaining blade side shift needed if any and (3) the detected steering angle θ.

In an embodiment, these goals are enforced in order. For example, an articulation adjustment needed to avoid having the rear wheels impact the curb will take priority over any adjustments needed to provide additional blade side shift or to cause the front and rear wheels to track. Moreover, if no risk of curb impact is apparent, any adjustment needed to provide additional blade side shift will take priority over adjustments needed to cause the front and rear wheels to track. Finally, if articulation adjustments are not needed to avoid curb impact or to provide side shift, then articulation adjustment to allow the wheels to track may be made.

In addition, in one aspect, a warning or indicator may be provided for the operator when articulation is being actively changed by the controller 94. In an embodiment, if the articulation available within the above limits is not sufficient to allow the blade 30 to continue tracking the curve, the controller 94 may additionally adjust the blade circle shift to provide additional range of blade side movement.

The manner of linking the detected steering angle θ to a desired articulation angle α for wheel tracking may be executed via any suitable method. For example, the process described in U.S. Patent Application Publication No. 20110035109 controls articulation based on steering angle in a manner such that a rear centerline point will track a front centerline point. It will be appreciated that other types of steering-based articulation control may be used instead depending upon the implementation environment. For example, rather than tracking front wheel steering, articulation may be used to accentuate or dampen steering inputs.

Returning to FIG. 7, as the machine 10 proceeds along the marker, the controller 94 determines at stage 184 whether the operator has steered the machine 10 out of range of the marker, and lifts the blade 30 and reverts to manual control at stage 186 if this has occurred. Otherwise, the process 160 loops back to stage 174 to reevaluate and refine blade position as the machine 10 moves forward. Even without movement of the blade 30 itself relative to the machine 10, it will be appreciated that changes in blade position relative to the marker may occur because of machine movement due to steering and articulation and/or because of lateral variations in the position of the marker.

In an alternative embodiment, the controller 94 adjusts frame articulation and blade position in conjunction with one another rather than adjusting these variables sequentially, based on marker trends and/or upcoming marker features such as curvature of the marker. For example, if the blade edge is detected to be too far from the curb or other marker, the controller 94 may determine whether the marker curves within an upcoming predetermined distance such as a machine length, 30 feet, or other desired measure. If the marker does curve within the established distance, the controller 94 may wait to receive an anticipated steering change and may then use articulation adjustment in conjunction with blade shift to close the gap between the blade edge and the marker to the appropriate distance.

Similarly, the controller 94 may utilize frame articulation and blade shift to balance one another to allow the greatest remaining freedom of adjustment as the machine 10 continues forward. For example, if the current blade shift position is far off center and nearing a travel limit to the left or right, the controller 94 may readjust the blade shift toward the center while adjusting the frame articulation to account for the altered blade edge position relative to the marker.

In a specific example, if the blade edge is displaced too far off center toward the marker, the controller 94 may shift the blade 30 back toward center while reducing the articulation, with the result that the gap between the blade edge and the marker remains as desired. However, as noted above, the operator may steer so far from the marker that the full range of blade shift and frame articulation are not sufficient to keep the gap at the appropriate measure. In this case, as in stages 168 and 184 of FIGS. 6 and 7 respectively, the controller 94 may consider the machine 10 to be out of range and may terminate the automation process of interest.

Returning briefly to FIG. 5, if stage 154 directs the process 150 to jump point C, then fully automatic control has been selected, and the controller 94 executes the process 188 shown in FIG. 8. In an embodiment, fully automatic control entails control of machine blade side shift and articulation to maintain a set gap to the curb or other marker. In addition, machine speed may optionally be controlled to remain below a predetermined set point. Alternatively, the process 188 may require a check of machine speed prior to beginning as discussed with respect to other embodiments above.

In executing the process 188, the controller 94 initially receives a marker sensor position signal or determines an appropriate direction for the marker sensor and positions the marker sensor automatically at stage 190 as discussed above. At this time, the controller 94 may prompt the operator via a visual display to set blade tip, tilt, and circle shift and optionally to set an appropriate gap between the blade and the curb or other marker, e.g., via a display driven process as discussed above.

The controller 94 then determines the distance from the blade 30 to the detected marker at stage 192 and moves the blade 30 at stage 194 to the extent needed so that the distance from the blade edge to the marker matches the preset blade gap distance if the user has not manually set the gap and to the extent that such movement does not violate a preset range limit.

As the machine 10 then moves forward, the controller 94 maintains the gap initially set between the blade 30 and the selected curve primarily by adjusting blade side shift via the center shift cylinder 40 at stage 194. If the blade shift is limited to less than the actual available range of blade side shift as discussed above, then any unmet side shift requirement may be accommodated in the later steps. In this embodiment, a warning indicator may be provided when the side shift reaches the preset limit value.

At stage 196, the controller 94 controls the machine steering angle θ and frame articulation angle α to provide any additional side shift to the extent such is compatible with any rules of motion such as disallowing impact of the rear wheels on the curb or other marker. Thus, in stage 196, the controller 94 adjusts the steering angle and articulation angle to move the machine 10 closer to or farther away from the curb in order to assist in maintaining the gap at the desired value while also keeping the blade side shift within an acceptable range, to the extent the adjustment does not violate a rule of motion.

The relationship between the steering angle θ and articulation angle α may be specified in any desired manner, but in an embodiment, steering and articulation angles are set such that a rear centerline point will track a front centerline point as discussed above. If the articulation available within the above limits is not sufficient to allow the blade 30 to continue tracking the curve without violating a restriction as noted above, the controller 94 may additionally adjust the blade circle shift to provide additional range of blade side movement.

As the machine 10 proceeds along the marker, the controller 94 adjusts steering angle and frame articulation angle in concert at stage 198 to follow the target curve. If the curve ends as determined at stage 200 (except for momentary termination with an expected resumption, e.g., after a gap) or if the user manually terminates the automatic control process as determined at stage 202, then the process 188 ends. Otherwise, the process 188 continues to execute stage 198 in order to follow the target curve.

Although not explicitly shown in FIGS. 6-8, the controller 94 may control the machine speed during any automated mode, e.g., to maintain a constant speed in addition to ensuring that machine speed is less than a predetermined threshold speed. For example, automatic speed control may be useful during operations in environments having frequent grade changes.

In an embodiment, the controller 94 exits any automatic blade gap setting mode in the event that the operator either attempts to control an automated or fixed function such as blade depth or shift, or manipulates a manual control, such as steering, to the extent that the machine 10 is placed beyond an automatically correctable range. Similarly, if the operator at any time switches from an automatic mode into manual mode, the controller 94 returns the machine 10 to manual control. In a further embodiment, the controller 94 causes the blade 30 to be lifted when switching out of any automatic mode into manual mode.

### INDUSTRIAL APPLICABILITY

In general terms, the present disclosure sets forth a system and method for control of a motor grader during operations that track a roadway marker such as a curb. In one embodiment, the system and method control one or more aspects of the motor grader operation during grading near a cul-de-sac curb. In a further embodiment, a machine operator may select a mode of operation, with exemplary modes of operation including a manual mode, a blade automation mode, a blade and steering automation mode, and a full auto mode wherein blade shift, machine steering, and machine articulation are automated to track the marker.

At any time during automated operation, the operator may change modes or, in an embodiment, simply control the machine out of a current automated mode, in which case the machine reverts to the manual mode. The method and system for motor grader operation described herein maintain a desired gap between the blade and the marker to prevent the motor grader blade from impacting the marker during operation, especially during operations adjacent curved markers such as cul-de-sac curbs.

In addition to allowing an operator to maintain a motor grader blade at a fixed distance from a curb or other marker, the distance data gathered in this process can also be used in a historical manner to provide a record of a grading process. For example, the data are used in an embodiment to provide the operator with a map of areas that have been graded with the desired gap, i.e., what areas have been traversed with blade control engaged. This record may be optionally superimposed on a site map to provide an operator or supervisor with a record of work done and a representation of work yet to be done. In a further embodiment, the display includes one or more indicators showing areas that experienced issues to be corrected or noted, such as areas where the gap-to-curb setting was violated.

It will be appreciated that the present disclosure provides an effective and efficient mechanism and control system for motor grader control. Not only do the described system and method generally improve operator comfort and reduce operator fatigue, but they also yield a high-quality grading product with less operator training and experience than might otherwise be required.

While only certain examples of the described system and method have been set forth, alternatives and modifications will be apparent from the above description to those skilled in the art. These and other alternatives are considered equivalents and within the spirit and scope of this disclosure and the appended claims.

What is claimed is:

1. A method of controlling a motor grader with respect to a roadway marker, the motor grader having an articulated frame, a plurality of steerable traction devices, an object sensor, and a blade, the blade being laterally movable in a side shift direction, the method comprising:
receiving an operator selection from an operator of the motor grader indicating that the operator desires automatic blade control;
automatically determining a distance between a feature of the roadway marker and an edge of the blade closest to the roadway marker via the object sensor; and
automatically moving the blade relative to the roadway marker such that the distance between the feature of the roadway marker and the edge of the blade closest to the roadway marker substantially conforms to a target distance.

2. The method of controlling a motor grader with respect to a roadway marker in accordance with claim 1, wherein the roadway marker is a curb.

3. The method of controlling a motor grader with respect to a roadway marker in accordance with claim 1, wherein the object sensor includes a first object sensor positioned to detect objects on a first side of the motor grader and a second object sensor positioned to detect objects on a second side of the motor grader, and wherein determining the distance between the roadway marker and the edge of the blade closest to the roadway marker automatically via the object sensor comprises detecting a distance to the roadway marker from one of the first and second object sensors.

4. The method of controlling a motor grader with respect to a roadway marker in accordance with claim 1, wherein the object sensor includes a single positionable object sensor, and wherein determining the distance between the roadway marker and the edge of the blade closest to the roadway marker automatically via the object sensor comprises first directing the single positionable object sensor toward the roadway marker.

5. The method of controlling a motor grader with respect to a roadway marker in accordance with claim 1, wherein the target distance is an operator-selected distance.

6. The method of controlling a motor grader with respect to a roadway marker in accordance with claim 1, wherein automatically moving the blade relative to the roadway marker comprises actuating a side shift mechanism to shift the blade relative to the motor grader.

7. The method of controlling a motor grader with respect to a roadway marker in accordance with claim 1, wherein the operator selection further indicates that the operator desires automated articulation control, the method further comprising detecting a steering command from the operator and automatically providing an articulation command to set a degree of frame articulation based on the detected steering command.

8. The method of controlling a motor grader with respect to a roadway marker in accordance with claim 7, wherein the plurality of steerable traction devices includes a set of front wheels associated with the motor grader, and wherein the motor grader further includes a set of rear wheels, and wherein the articulation command is configured to cause the rear wheels to track the front wheels.

9. The method of controlling a motor grader with respect to a roadway marker in accordance with claim 1, wherein the operator selection further indicates that the operator desires fully automatic blade, steering and articulation control, and wherein automatically moving the blade relative to the roadway marker further comprises actuating a shift actuator to move the blade along the side shift direction relative to the motor grader and automatically providing a steering command and an articulation command, such that the resultant blade movement relative to the roadway marker is sufficient to maintain the distance between the feature of the roadway marker and the edge of the blade closest to the roadway marker substantially at the target distance.

10. The method of controlling a motor grader with respect to a roadway marker in accordance with claim 1, wherein the object sensor is one of a LIDAR sensor, a LADAR sensor, and a camera.

11. The method of controlling a motor grader with respect to a roadway marker in accordance with claim 1, wherein automatically moving the blade relative to the roadway marker includes automatically moving the blade to follow a curve that is at the target distance from the feature of the roadway marker.

12. The method of controlling a motor grader with respect to a roadway marker in accordance with claim 11, wherein the feature of the roadway marker includes a gap in the direction of travel, and wherein the curve continues across the gap.

13. A motor grader comprising:
an articulated frame having one or more steerable traction devices at one end of the articulated frame and one or more propulsive traction devices at an opposite end of the articulated frame;
a blade positioned beneath the articulated frame to grade a ground surface beneath the motor grader;
an articulation actuator located and configured to establish an articulation angle of the articulated frame, a steering actuator located and configured to establish a steering angle of the one or more steerable traction devices, and a side shift actuator located and configured to shift the blade relative to the articulated frame;
at least one object sensor located and configured to detect a roadway marker adjacent the motor grader and to provide information indicative of a distance between the blade and the roadway marker; and
a controller configured to receive a mode selection signal from a mode selector switch identifying a desired mode of operation from among a plurality of available modes including a manual mode, an automatic blade control mode wherein the controller controls the blade side shift actuator to maintain a target distance between the blade and the roadway marker, an automatic blade and articulation control mode wherein the controller controls the blade side shift actuator and the articulation actuator to maintain the target distance between the blade and the roadway marker as the machine is steered by the operator, and a fully automatic control mode wherein the controller controls the blade side shift actuator, articulation actuator, and steering actuator to direct the motor grader while maintaining the target distance between the blade and the roadway marker.

14. The motor grader in accordance with claim 13, wherein the at least one object sensor includes a single repositionable object sensor and wherein the controller is configured to utilize the single repositionable object sensor to determine on which side of the motor grader the roadway marker lies and to position the object sensor to detect the distance to the roadway marker.

15. The motor grader in accordance with claim 13, wherein the controller is further configured to detect a curve of a feature of the roadway marker, and to cause the blade to remain a target distance from the curve when the mode selection signal identifies one of the automatic blade control mode, automatic blade and articulation control mode, and fully automatic control mode.

16. The motor grader in accordance with claim 13, wherein the controller is further configured to detect a steering command from the operator and provide an articulation command to set a degree of frame articulation based on the detected steering command when the mode selection signal identifies the automatic blade and articulation control mode of operation.

17. The motor grader in accordance with claim 13, wherein the controller is further configured to return to the manual mode of operation when the operator attempts manual control of an automated function.

18. The motor grader in accordance with claim 13, wherein the controller is further configured to return to the manual mode of operation when the operator steers the motor grader beyond a predetermined range of the roadway marker.

19. A method of controlling a motor grader having a blade, a blade side shift actuator, an object sensor to detect a distance to a curb, one or more steerable wheels, a steering actuator, an articulated frame, and an articulation actuator, the method comprising:
periodically determining via the object sensor a gap between the blade and a feature of the curb; and
automatically maintaining the gap at a target distance via the object sensor in the absence of user intervention by automatically manipulating one or more of the blade side shift actuator, steering actuator, and articulation actuator.

20. The method of controlling a motor grader in accordance with claim 19, wherein the feature of the curb exhibits a curve substantially along its length in the direction of travel and wherein maintaining the gap at the target distance includes causing the blade to follow the curve at the target distance from the feature.

21. The method of controlling a motor grader in accordance with claim 19, wherein the object sensor includes a first object sensor positioned to detect objects on a first side of the motor grader and a second object sensor positioned to detect objects on a second side of the motor grader, and wherein periodically determining via the object sensor a gap between the blade and a feature of the curb comprises detecting a distance to the curb from one of the first and second object sensors.

22. The method of controlling a motor grader in accordance with claim 19, wherein the object sensor includes a single positionable object sensor, and wherein determining a gap between the blade and a feature of the curb comprises first directing the single positionable object sensor toward the curb.

23. The method of controlling a motor grader in accordance with claim 19, wherein the target distance is an operator-selected distance and wherein the object sensor includes a camera, the method further comprising:
obtaining an image via the camera, the image including the curb and the blade;
displaying the obtained image to the operator; and
receiving from the operator an identification of the target distance based on the displayed image.

24. The method of controlling a motor grader in accordance with claim 23, wherein displaying the obtained image to the operator comprises displaying the image via a touch screen display, and wherein receiving an identification of the target distance from the operator based on the displayed image comprises receiving a touch screen input from the operator.

25. The method of controlling a motor grader in accordance with claim 19, further comprising receiving an operator selection identifying an automatic operating mode which is one of a blade control mode, a blade and articulation control mode, and a blade, articulation, and steering control mode, and wherein automatically maintaining the gap at the target distance comprises adjusting the blade position via the blade side shift actuator if the operator selection identifies the blade control mode, adjusting blade position via the blade side shift actuator and articulation actuator if the operator selection identifies the blade and articulation control mode, and adjusting blade position via the blade side shift actuator, articulation actuator and steering actuator if the operator selection identifies the blade, articulation, and steering control mode.
